(19) United States
(12) Patent Application Publication
(10) Pub. No.: US 2019/0005507 A1
(43) Pub. Date: Jan. 3, 2019

(54) SYSTEMS IMPLEMENTING SOLID-WASTE CARBON EXCHANGE

(71) Applicant: Rubicon Global Holdings, LLC, Altanta, GA (US)

(72) Inventors: Philip RODONI, Decatur, GA (US); Nikishka IYENGAR, Atlanta, GA (US)

(73) Assignee: Rubicon Global Holdings, LLC, Altanta, GA (US)

(21) Appl. No.: 15/635,715

(22) Filed: Jun. 28, 2017

(51) Int. Cl. G06Q 30/00; B09B 1/00; G06Q 10/00

(52) U.S. Cl. CPC G06Q 30/018; G06Q 10/30; B09B 1/00

(57) ABSTRACT

A system is disclosed for managing waste. The system may include a first portal to generate information associated with collection and final disposition of solid waste, and a second portal to generate a protocol for registering, verifying, and accounting for an amount of solid waste diverted from a landfill to a recycling facility. The system may further include a processing unit configured to receive the information and the protocol, to determine a baseline carbon footprint based on the information and the protocol, and to determine a reduced carbon footprint resulting from content diversion. The processing unit may also be configured to register the baseline and reduced carbon footprints, to receive a waste coin based on an offset between the baseline and reduced carbon footprints, and to selectively cause at least one of the baseline carbon footprint, the reduced carbon footprint, and the waste coin to be shown on a display.

### TECHNICAL FIELD

The present disclosure relates generally to a system for managing waste, and more particularly, to a management system implementing a solid-waste carbon exchange.

### BACKGROUND

A greenhouse gas is a gas that causes radiation from the sun to be trapped within the earth's atmosphere, resulting in an increase in ambient temperature. Carbon dioxide is one example of a greenhouse gas. Carbon dioxide is primarily generated via the burning of fossil fuels like coal, oil and natural gas. Most industrial organizations rely on the burning of fossil fuels during normal operations (e.g., to create electricity, to process materials, to transport goods, etc.). A carbon footprint is a measurement of carbon dioxide contributable to an organization's operation.

An organization may be classified as having a positive carbon footprint, a neutral carbon footprint, or a negative carbon footprint. Most organizations are carbon-positive, meaning that their operation results in a net positive amount of carbon dioxide being released to the atmosphere. To be carbon-neutral is to balance the amount of carbon dioxide released into the atmosphere with an equal amount of carbon offsets received from a carbon-negative organization. An organization may be considered carbon-negative when the organization removes more carbon dioxide from the atmosphere than it generates. The negative difference between the amount of carbon generated and removed is considered a carbon offset. In some situations, carbon offsets can be created by a reduction in a carbon footprint, even if the organization remains carbon-positive.

Virtual representations of carbon offsets may be traded between organizations, such that an otherwise carbon-positive organization can comply with environmental regulations of carbon neutrality. In some instances, even when greenhouse gases are not regulated, a particular organization may still trade in carbon offsets as a way to publically show support for the environment.

One untapped source of carbon offsets may include recycling of solid waste. Recycling solid waste reduces greenhouse gases produced at a landfill, as well greenhouse gases that would otherwise have been generated in association with production of new stock material replaced by the recycled material. In most instances, at least some amount of solid waste discarded by a particular organization is recyclable. If that amount of solid waste can be quantified and then recycled, a corresponding tradable carbon offset may be generated.

The disclosed system is directed to overcoming one or more of the problems set forth above and/or other problems of the prior art.

### SUMMARY

In one aspect, the present disclosure is directed to a waste management system. The waste management system may include at least a first portal configured to generate information associated with collection of solid waste and final disposition of collected solid waste. The waste management system may also include a second portal configured to generate at least one protocol for registering, verifying, and accounting for an amount of collected solid waste diverted from a landfill to a recycling facility. The waste management system may further include a display, a memory having computer-executable instructions stored thereon, and a processing unit in communication with the at least a first portal, the second portal, the display, and the memory. The processing unit may be configured to execute the instructions to receive the information from the at least a first portal, to receive the at least one protocol from the second portal, to determine a baseline carbon footprint based on the information and the at least one protocol, and to determine a reduced carbon footprint resulting from content diversion based on information subsequently received from the at least one portal according to the at least one protocol. The processing unit may also be configured to execute the instructions to register via the second portal the baseline carbon footprint and the reduced carbon footprint via the second portal, receive via the second portal a waste coin based on an offset between the baseline carbon footprint and the reduced carbon footprint, and selectively cause at least one of the baseline carbon footprint, the reduced carbon footprint, and the waste coin to be shown on the display.

In another aspect, the present disclosure is directed to another waste management system. This waste management system may include a locating device configured to generate a first signal associated movement of a service vehicle during at least one of collecting of solid waste and disposing of the solid waste at a landfill or recycling facility, and at least one sensor configured to generate a second signal indicative of an amount of solid waste collected by the service vehicle and delivered to the landfill or recycling facility. The waste management system may also include a display, a memory having computer-executable instructions stored thereon, and a processing unit in communication with the locating device, the at least one sensor, and the memory. The processing unit may be configured to execute the instructions to determine a baseline carbon footprint based on the first signal according to a carbon emission protocol and, after implementation of a content diversion plan associated with the solid waste, determine a reduced carbon footprint based on the first signal according to the carbon emission protocol. The processing unit may also be configured to execute the instructions to register the baseline carbon footprint and the reduced carbon footprint with a governing body, receive a waste coin from the governing body based on an offset between the baseline carbon footprint and the reduced carbon footprint, and selectively cause at least one of the baseline carbon footprint, the reduced carbon footprint, and the waste coin to be shown on the display.

### BRIEF DESCRIPTION OF THE DRAWINGS

FIG. 1 is an isometric illustration of an exemplary disclosed waste management environment;

FIG. 2 is a diagrammatic illustration of an exemplary disclosed system that may be used to manage the environment of FIG. 1; and

FIG. 3 is a flowchart depicting an exemplary disclosed method that may be performed by the system of FIG. 2.

### DETAILED DESCRIPTION

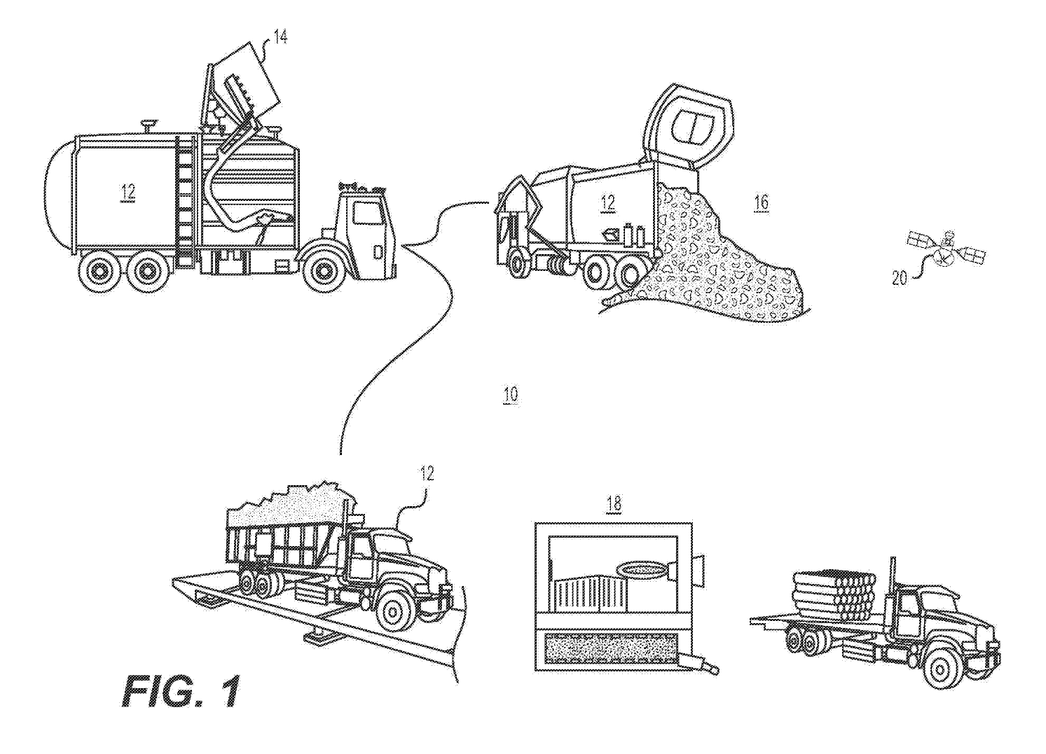

FIG. 1 illustrates an exemplary waste management environment (“environment”) 10, at which one or more service vehicles 12 are providing waste services. Environment 10 may include a retail store, a factory, a government building, a residence, an apartment building, or another customer location having one or more receptacles 14 that require services from vehicle 12. The services may include, for example, the retrieval of solid waste from inside of receptacles 14, the retrieval of receptacles 14 containing solid waste, and/or the transportation of receptacles 14 and/or solid waste to a final disposition location (e.g., to a landfill 16 and/or to a recycling facility 18).

Solid waste collected by service vehicle 12 may be disposed of in any number of different ways. For example, all of the solid waste may be dumped at landfill 16 and allowed to decompose naturally. In another example, particular constituents of the solid waste may be recycled at facility 18. For example, cardboard found in the solid waste may be baled and delivered to a mill for processing into paper; aluminum cans may be bundled and taken to a foundry for smelting into billets; glass may be crushed and melted into blocks or panes; etc. Solid waste that is disposed of at landfill 16 may be associated with a larger carbon footprint (e.g., a greater amount of carbon dioxide being released into the atmosphere) than solid waste that is recycled at facility 18. In some situations, the solid waste collected by service vehicle 12 may first be transported to a sorting facility, before some or all of the waste is then passed on to one or more recycling facilities 18 and the remaining waste is directed to landfill 16. For the purposes of this disclosure, facility 18 is meant to encompass the sorting facility.

As service vehicle 12 moves about environment 10 (e.g., between customer locations, landfill 16, and/or facility 18), a satellite 20 or other tracking device may monitor the movements of service vehicle 12 and the associated changes made to environment 10 (e.g., waste pickup, transportation, dumping, delivery, etc.).

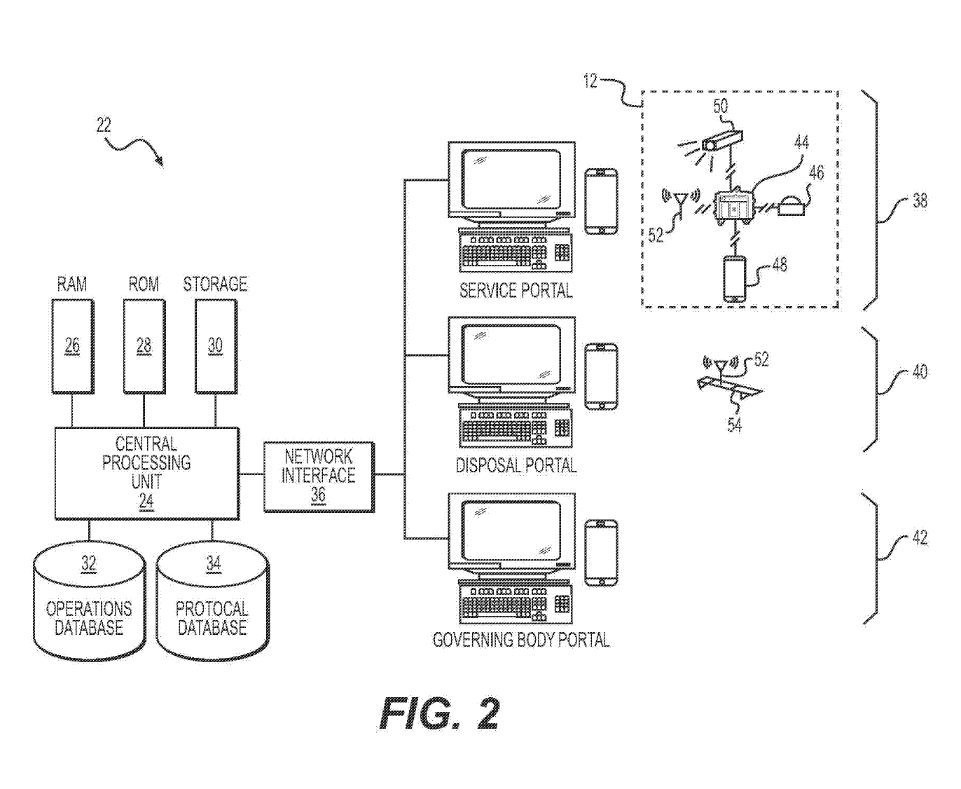

An exemplary system 22 that can be used to manage operations within environment 10 is shown in FIG. 2. System 22 may include, among other things, a central processing unit 24, a random access memory (RAM) 26, a read-only memory (ROM) 28, a storage 30, at least one database (e.g., an operations database 32 and a protocol database 34), a network interface 36, and at least one user portal (e.g., a service portal 38, a disposal portal 40, and a governing body portal 42). As will be explained in more detail below, CPU 24 may be configured to receive data from different users via portals 38-42, and to compare, process, record, and share the data with the same and/or with other users via the same or different portals. It is contemplated that system 22 may include additional, fewer, and/or different components than those listed above. It is understood that the type and number of listed devices are exemplary only and not intended to be limiting.

CPU 24 may include an arrangement of electronic circuitry configured to perform arithmetic, logic, input/output, and control operations during sequential execution of pre-programmed instructions. The instructions may be loaded from ROM 28 into RAM 26 for execution by CPU 24. It should be noted that, although CPU 24 is shown and described as a single “unit”, it is contemplated that the functions of CPU 24 could alternatively be completed by any number of co-located or remotely distributed and cooperating processing units, as desired. Numerous commercially available microprocessors may be configured to perform the functions of CPU 24. Further, the microprocessors may be general-purpose processors or specially constructed for use in implementing the disclosed concepts.

Storage 30 may embody any appropriate type of mass storage provided to hold information that CPU 24 may need in order to perform the disclosed processes. For example, storage 30 may include one or more hard disk devices, optical disk devices, or other storage devices that provide sufficient storage space.

Databases 32 and/or 34 may contain any information relating to particular waste service, transportation, disposal, and/or carbon-related protocol records under analysis. The information stored within databases 32 and/or 34 may come from multiple different sources and be provided at any time and frequency. For example, the information could be automatically uploaded by components located onboard service vehicle 12, manually entered by a service provider (e.g., a vehicle operator), automatically uploaded by landfill and/or recycling components, manually entered by a disposal provider, automatically uploaded by regulatory components, manually entered by the governing body, etc. The information may be entered live (e.g., as the information is collected and/or observed by a vehicle operator, a landfill attendant, a recycling facility employee, etc.), entered based on a predetermined schedule (e.g., based on regular uploads of service and/or protocol data), continuously streamed (e.g., via a live link to service and/or protocol information), intermittently pulled from “the cloud” (e.g., from social media posts about applicable information), or obtained in any other manner at any other time and frequency. It is contemplated that one or both of databases 32, 34 may function using block-chain technology, wherein all information stored within the database(s) is shared publically and continually reconciled. In this manner, the stored information may be easily verifiable.

In addition to the waste service, transportation, disposal, and protocol information, databases 32 and/or 34 may also include analysis tools for analyzing the information stored therein. CPU 24 may use databases 32 and/or 34 to make comparisons and/or determinations regarding relationships and/or trends relating to particular customers, customer locations, service vehicles 12, service vehicle drivers, final disposition locations (e.g., landfill 16 and/or recycling facility 18), protocols, uses of system 22, and other such pieces of information. CPU 24 may pull information from databases 32 and/or 34, manipulate the information, and analyze the information. CPU 24 may also update the information, store new information, and store analysis results within databases 32 and/or 34, as desired.

CPU 24 may communicate with a user of system 22 (e.g., a user accessing portal 38, 40, and/or 42) via network interface 36. Network interface 36 may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components. For example, the communication links may include non-proprietary links and protocols, or proprietary links and protocols based on known industry standards, such as J1939, RS-220, RP1210, RS-422, RS-485, MODBUS, CAN, SAEJ1327, Bluetooth, the Internet, an intranet, 802.11 (b, g, n, ac, or ad), or any other communication links and/or protocols known in the art.

Each of portals 38-42 can include one or more of a router, an Ethernet bridge, a modem (e.g., a wired or wireless modem), or any other conventional computing components known in the art (not shown) such as a processor, input/output (I/O) ports, a storage, and a memory. The processor of each portal 38-42 can include one or more processing devices, such as microprocessors and/or embedded controllers. The storage can include volatile or non-volatile, magnetic, semiconductor, tape, optical, removable, non-removable, or other type of computer-readable medium or computer-readable storage device. The storage can be configured to store software programs (e.g., apps) downloaded from CPU 24 via network interface 36 and/or other information that can be used to implement one or more of the disclosed processes. The memory can include one or more storage devices configured to store the downloaded information. Each of portals 38-42 may be able to communicate with CPU 24, with databases 32 and/or 34, and/or directly with each other via network interface 36.

Each of portals 38-42 may provide a graphical user interface (GUI) that is configured to display information to users thereof, and that includes a means for receiving input from the user. In one embodiment, an exemplary portal is a computer (e.g., a laptop or desktop computer) having a console and a keyboard/mouse. In another embodiment, an exemplary portal is a handheld mobile device, such as a smart phone or a tablet having a touchscreen display and/or a keyboard. Other types of portals may also be utilized. The GUI of portals 38-42 may allow the user to receive (e.g., audibly, tactilely, and/or visually) information from system 22 via network interface 36, to upload information to system 22, and/or to correspond with other users of system 22.

Portal 38 may be dedicated for use by a service provider (e.g., a vehicle operator, an account representative, a service manager, a regulatory controller, etc.). It is contemplated that any number of portals 38 may be simultaneously connected to network interface 36 for use by any number of different users. Each such portal 38 may allow the service provider to log into system 22 (e.g., via a web-based program, an internet site, or a mobile app) and to upload, download, and/or monitor information related to a particular service event (e.g., a historic event or a live event, such as transportation of vehicle 12 to a customer location, onloading of solid waste, transportation of the solid waste to a final disposition location, and/or offloading of the solid waste), to view a carbon-related protocol, to compare aspects of particular service events to aspects of particular protocols, to alert operators and/or customers of protocol-related issues, to share (e.g., publish, post, email, send, announce, etc.) service and/or protocol-related information with other users (e.g., users of portals 40 and/or 42), to design and/or implement a content diversion plan, and/or for other similar purposes.

In one example, service information generated onboard service vehicle 12 may be uploaded to system 22 via portal 38. This information may include, for example, a location at which service vehicle 12 stops and onloads solid waste, an identification of a particular receptacle 14 from which the solid waste is onloaded, a time stamp of the onload, an amount of solid waste onloaded, a mix of onloaded solid waste, a location at which service vehicle 12 stops and offloads solid waste, a time stamp of the offload, an amount of offloaded solid waste, and/or a mix of offloaded solid waste. The service information may be chronologically stored within database 32, for viewing and verification via any one or more of portals 38-42.

The service information uploaded to system 22 may be generated onboard service vehicle 12 in any number of different ways. In one example, each vehicle is equipped with a controller 44, a locating device 46, and at least one of a manual input device 48 and a sensor (e.g., an optical sensor and/or a performance sensor) 50. Controller 44 may be in communication with each of these other components and/or with CPU 24 via a communication device 52. Controller 44 may be able to provide CPU 24 (e.g., via a communication device 52) with the location of each service vehicle 12 during each onload, characteristics and locations of receptacles 14 being moved by and/or in a vicinity of each service vehicle 12, an amount and/or mix of waste onloaded by each service vehicle 12 at each location and/or from each receptacle 14, the location of each service vehicle 12 during each offload, and/or an amount and/or mix of waste offloaded at a particular location.

Locating device 46 may be configured to generate signals directed to controller 44 that are indicative of a geographical position and/or orientation of service vehicle 12 relative to a local reference point, a coordinate system associated with environment 10, a coordinate system associated with Earth, or any other type of 2-D or 3-D coordinate system. For example, locating device 46 may embody an electronic receiver configured to communicate with satellites 20 (referring to FIG. 1), or a local radio or laser transmitting system used to determine a relative geographical location of itself. Locating device 46 may receive and analyze high-frequency, low-power radio or laser signals from multiple locations to triangulate a relative 3-D geographical position and orientation. Based on the signals generated by locating device 46 and based on known kinematics of service vehicle 12, controller 44 may be able to determine in real time, the position, heading, travel speed, acceleration, and/or orientation of service vehicle 12. This information may then be used by controller 44 to update in an electronic map or database of environment 10 the location of service vehicle 12, the location of receptacles 14, and/or the location of solid waste collected, delivered, and/or dumped by service vehicle 12.

It is contemplated that locating device 46 may take another form, if desired. For example, locating device 46 could be an RFID reader configured to interact with an RFID tag located within environment 10 (e.g., at a customer location, on receptacle 14, at landfill 16, at recycling facility 18, etc.), or another type of scanner configured to read another type of indicia (e.g., a barcode) within environment 10. Based on the reading of the RFID tag or other indicia, the location and/or orientation of service vehicle 12 may be linked to the known location of the RFID tag or other indicia within environment 10.

Manual input device 48 may provide a way for an operator of service vehicle 12 to input information regarding observances made while traveling around environment 10. For example, the operator may be able to enter an amount, condition, and/or type of solid waste observed at a particular location, an amount and/or mix of waste in or around receptacle 14, a fill status of a particular receptacle 14, a location of receptacle 14, an amount and/or type of solid waste being transported, an end-disposition location of the solid waste, and/or other information about receptacle 14 and the waste engaged by, loaded into, transported, dumped, or otherwise processed by service vehicle 12. The information may be input in any number of ways, for example via a cab-mounted touch screen interface, via one or more buttons, via a keyboard, via speech recognition, via a mobile device (e.g., a smartphone or tablet) carried by the operator, via a camera, or in another manner known in the art. For example, the operator may be able to capture an image via input device 48 of a receipt for solid waste delivered to landfill 16 and/or facility 18, and then use input device 48 to upload the image to database 32 via communication device 52, network interface 36, and/or CPU 24.

In one example, sensor 50 is an optical sensor mounted at any location suitable for capturing image data associated with the waste inside of receptacle 14, waste falling from receptacle 14 into service vehicle 12, waste inside of service vehicle 12, and/or waste being dumped out of service vehicle 12. For example, sensor(s) 50 may be mounted onboard service vehicle 12, onboard receptacle 14, and/or offboard at a customer location.

As an optical sensor, each sensor 50 may be configured to capture digital image data that can be viewed in real or near-real time and/or downloaded for later viewing. For example, sensor 50 may be a still camera and/or a video camera configured to capture IR, ultraviolet, and/or full-spectrum images as digitized data. The digitized data may then be stored within an internal memory, communicated to controller 44 (e.g., via Bluetooth), and/or communicated to CPU 24 via wired or wireless technology. In some instances, the digitized data may be streamed via Bluetooth to controller 44, which may then store the data for later download and/or relay the data to CPU 24 via communication device(s) 52. As will be explained in more detail below, the image data may be shown on a display and viewed by a human operator as part of a waste tracking process.

In another embodiment, sensor 50 is a performance sensor configured to monitor a parameter associated with solid waste being loaded onto and/or dumped from service vehicle 12, and to generate corresponding signals (e.g., performance data) indicative thereof. In this embodiment, sensor 50 may be located anywhere on or in service vehicle 12 and/or receptacle 14, and embody, for example, a load cell, a force gauge, a pressure sensor, a motion sensor, an acoustic sensor (e.g., a microphone), an accelerometer, or another type of sensor. In one example, signals generated by sensor 50 may correspond with an amount (e.g., weight and/or volume) and/or type of waste contained inside receptacle 14, dumped from receptacle 14 into vehicle 12, and/or dumped from vehicle 12. In another example, the signals generated by sensor 50 may correspond with completion of a service activity (e.g., that receptacle 14 was lifted, tilted, and/or dumped; that waste entered service vehicle 12; and/or that waste left service vehicle 12), without necessarily quantifying or categorizing the waste. This information may then be used to calculate the amount and/or mix of collected, transported, and/or dumped solid waste.

Controller 44 may be configured to manage communications between other onboard components and CPU 24. For example, controller 44 may receive signals from locating device 46, input device(s) 48, and sensor(s) 50, and correlate the signals, filter the signals, buffer the signals, record the signals, or otherwise condition the signals before directing the signals offboard via communication device 52.

Communication device 52 may be configured to facilitate communication between connected devices. Communication device 52 may include hardware and/or software that enable the sending and/or receiving of data messages through a communications link. The communications link may include satellite, cellular, infrared, radio, and any other type of wireless communications. Alternatively, the communications link may include electrical, optical, or any other type of wired communications, if desired. In one embodiment, controller 44 may be omitted, and CPU 24 may communicate directly with locating device 46, input device(s) 48, and/or sensor(s) 50, via communication device 52, if desired. Other means of communication may also be possible.

Disposal portal 40 may be intended for use by each organization responsible for disposing of solid waste delivered to them by service vehicle 12 (e.g., for use by a landfill, sorting facility, and/or recycling facility owner or operator). It is contemplated that any number of portals 40 may be simultaneously connected to network interface 36 for use by any number of different disposal organizations. Each such portal 40 may allow an authorized user (e.g., the owner or operator) to access system 22 (e.g., via a web-based program, an internet site, or a mobile app) and to view and/or publish information relating to final disposition of particular amounts of particular types of solid waste delivered to the disposal location on particular dates by particular service vehicles 12 and/or service providers. For example, when service vehicle 12 delivers a load of solid waste to facility 18, the corresponding disposal portal 40 should provide information relating to where, when, what, and how much solid waste was received. In addition, disposal portal should provide information relating to where, when, and how that load of solid waste is finally disposed of (e.g., reduced to pulp, smelted, melted, sorted, passed on to landfill 16 and/or another facility 18, sold, traded, etc.). This disposal information may be chronologically stored within database 32, for viewing and verification via any one or more of portals 38-42.

The disposal information uploaded to system 22 may be generated in any number of different ways. In one example, each disposal location is equipped with at least one sensing and/or tracking device 54 (e.g., a scale, a serialized container, a meter, a camera, etc.) that is configured to generate signals corresponding the amount, location, and/or condition of the solid waste as it is received, processed, and/or transported away from the disposal location (e.g., throughout every step of the recycling and/or landfilling processes). Device 54 may be in communication with CPU 24 via a communication device 52 (and/or a dedicated disposal controller—not shown), for automated uploading of the disposal information. Alternatively, the movement of the solid waste through the disposal location and/or the status of the solid waste may be manually uploaded. In some instances, evidence (e.g., images, receipts, bills, ledger entries, tax records, manifests, etc.) of the amount, location, and/or state of the solid waste may be also be automatically and/or manually uploaded.

Governing body portal 42 may be dedicated for use by a governing body responsible for carbon-related protocols. In the disclosed embodiment, the governing body includes a tracking registry, a verification registry, and an accounting registry. The tracking registry may be responsible for establishing a carbon baseline (e.g., a measure of solid waste, such as a weight or a volume, and/or an equivalents number of carbon emission units) for each of its participating members (e.g., for each customer, customer location, and/or receptacle 14) according to one or more protocols agreed upon by the members and/or mandated by a government or other regulatory agency for a particular industry (e.g., by the state of California for the solid waste industry in California). For example, the participating members of a particular tracking registry may collectively agree that one megaton of CO₂ is to be considered equal to one unit of carbon. In addition, the same members may agree that a particular amount and/or mix of waste materials (e.g., of compostable materials, cardboard, plastic, wood, metal, etc.) generates one megaton of CO₂ when disposed of in a landfill. Accordingly, the tracking registry may be able to use the data provided via one or more of the other portals 38, 40, and/or 42 (e.g., the amount and/or mix of solid waste collected from a particular customer, customer location, and/or receptacles 14 within a specified period of time and dumped at landfill 16 or delivered to recycling facility 18) and/or stored within database 32 to calculate how many units of carbon are associated with business conducted by the customer and/or at a particular location. These units of carbon may then be considered as the baseline (e.g., as the carbon footprint) for the customer, location, and/or receptacle 14, and may be calculated, stored (e.g., within database 32), posted, shared, discussed, negotiated, or otherwise communicated via portal 42. Any time the same business thereafter produces less carbon than the previously calculated baseline, the difference (i.e., the number of units of carbon different between the current carbon production and the baseline amount) may be considered a carbon offset or credit.

The verification registry may be responsible for verifying the information collected by and/or reported to the governing body (e.g., by CPU 24 and/or via the other portals 38, 40, 42). In some instances, the verification registry is a third party contracted by the participating members (e.g., by the customer, the service provider, and/or the disposal organization) and/or by the governing body. The verification registry may analyze the information (e.g., the image data, time stamps, sensor data, manual input, final disposition information, receipts, affidavits, etc.) and compare the analysis to any reported carbon footprint (e.g., baseline and/or ongoing) and/or calculated carbon credit. For example, the verification registry may audit an amount of cardboard deposited by a particular customer and/or service provider at recycling facility 18 (e.g., via data received from via scale 54 or other tracking device, via receipts provided by the service provider, etc.), and compare that amount with a reported amount. The verification registry may then confirm or contest the reported information via portal 42. In some embodiments, the verification registry, instead of confirming or contesting reported information, may be the sole reporter of the information.

The accounting registry may be responsible for assigning unique identifiers to each unit of carbon credit, but only after the verification registry has verified the information. For example, the units of carbon credit may each be given a serial number by the accounting registry, which can then be used for trading purposes. For the purposes of this disclosure, a serialized unit of carbon credit may be considered a “waste coin” (i.e., a virtual monetary representation). The accounting registry may track waste coins during trading, such that each unit of carbon credit is claimed by only a single entity at any point in time. It should be noted that the accounting registry may accept carbon credit units for assignation and tracking that have been received by and/or verified by only particular tracking and verification registries. It is contemplated that accounting registry functions could be completed by the verification registry (or vice versa), if desired. In some embodiments, a single registry may perform tracking, verification, and accounting functions.

It is contemplated that any number of portals 42 may be simultaneously connected to network interface 36 for use by any number of different representatives associated with the same or different governing bodies (e.g., by a federal, state, or municipal agency and/or a voluntary market agency). Each such portal 42 may allow the representative to log into system 22 (e.g., via a web-based program, an internet site, or a mobile app) and to view protocols existing in database 34, to update the protocols, to remove protocols, and to respond to open inquiries regarding past, current, and/or proposed protocols, to generate waste coins, to track waste coins, etc.

Portal 42 may also be used to inform the governing body. For example, final disposition information regarding how and/or where particular service vehicles 12 and/or facilities 18 operate and comply with existing carbon-related protocols may be provided to the corresponding governing body via portal 42.

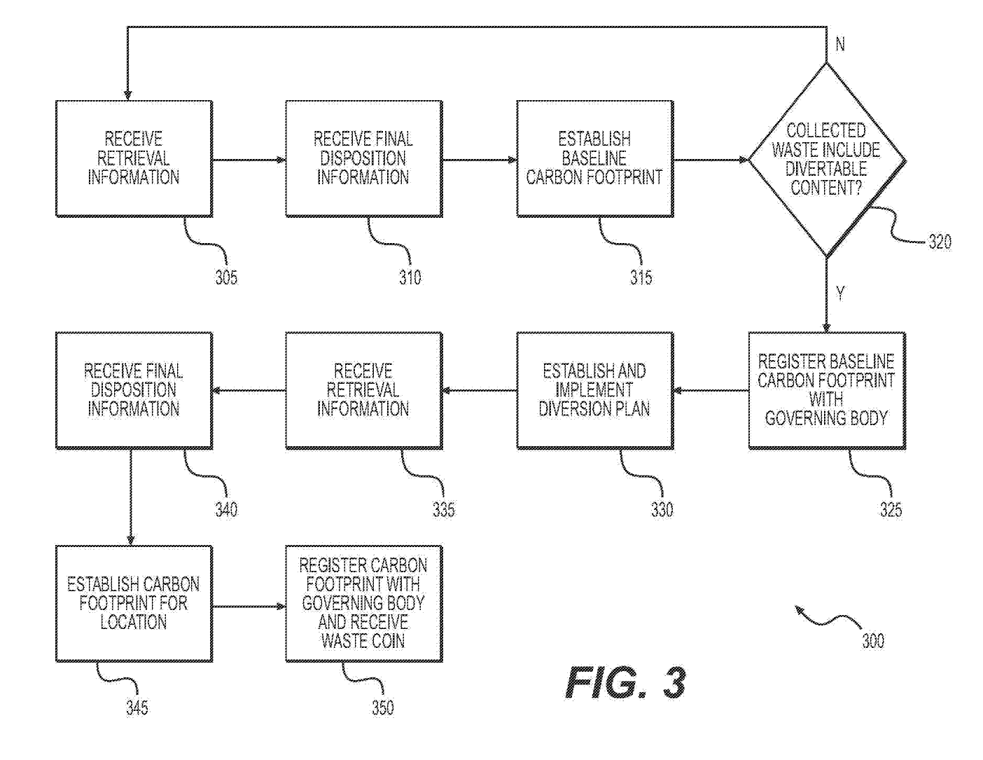

Based on the information received from portals 38-42, CPU 24 can be configured to execute instructions stored on computer readable medium to perform methods of waste management at environment 10. For example, CPU 24 may be configured to determine an amount of waste being produced at a particular customer location (e.g., to determine a carbon footprint for the location) and/or a type of the waste. In addition, CPU 24 may be configured to determine a mix of different types of materials (e.g., recyclables such as cardboard, plastic, wood, metal, etc.) contained in the waste. Determination of the mix may include, for example, an amount, a volume, a weight, a ratio, a percent, a value, an equivalent amount of greenhouse gases, a corresponding carbon credit, or another measure of one or more of the different types of material. In addition, CPU 24 may be configured to provide recommendations (e.g., a content diversion plan), such as how to comply with governing regulations, how to reduce a carbon foot print, how to track and monetize the reduction, etc. An exemplary waste management process 300 is illustrated in FIG. 3, and will be explained in more detail in the following section to further illustrate the disclosed concepts.

### INDUSTRIAL APPLICABILITY

The disclosed system may be applicable to the waste service industry, where knowing, tracking, quantifying, and/or reducing a carbon footprint (e.g., based on the amount and/or mix of solid waste generated and/or how the solid waste is disposed of) can be important and valuable. The disclosed system may be able to determine an amount and mix of solid waste retrieved from a customer, location, and/or receptacle and to also determine an amount and mix of solid waste disposed of within a landfill or recycling facility. In addition, the disclosed system may be able to generate a baseline carbon footprint based on the retrieval and disposal information. The disclosed system may be further able to implement a content diversion plan that should reduce the carbon footprint, verify the reduction, register carbon credits corresponding to the reduction, and facilitate profiting from the reduction. Operation of system 22 will now be described with reference to FIG. 3.

As shown in FIG. 3, method 300 may begin with the receipt of waste retrieval information by CPU 24 (step 305). This information may include, among other things, an indication that solid waste has been retrieved (e.g., via service vehicle 12); an amount of solid waste retrieved; a mix of the solid waste; a timing of the retrieval; and a location of the retrieval. In one example, the retrieval information is provided automatically (e.g., via locating device 46 and/or sensor(s) 50) as service vehicle 12 moves about and operates within environment 10 (referring to FIG. 1). In another example, the retrieval information is provided manually (e.g., via input device 48). The retrieval information may be stored within database 32, for example in chronological order.

CPU 24 may then receive final disposition information associated with the solid waste collected at step 305 (step 310). This information may include, among other things, an indication of an amount of the solid waste collected at step 305 that is subsequently received by landfill 16 and/or facility 18; a mix of the received solid waste; a timing of the receiving; and a location at which the solid waste is received. In one example, the final disposition information is provided automatically (e.g., via locating device 46, sensor(s) 50, and/or tracking device 54) as service vehicle 12 arrives at the location, is weighed, dumps the solid waste, leaves the location, etc. In another example, the final disposition information is provided manually (e.g., via input device 48 and/or portal 38 or 40). The final disposition information should reconcile with the retrieval information (e.g., if 10 tons of solid waste is retrieved, the same 10 tons of solid waste should be disposed of between landfill 16 and facility 18), and may be stored within database 32, for example in chronological order.

CPU 24 may use the retrieval information and the final disposition information to calculate a carbon footprint associated with the customer, customer location, and/or receptacle 14 from whence the solid waste was retrieved (step 315). For example, one or more maps (e.g., tables, algorithms, equations, etc.) stored in the memory of CPU 24 may be used to convert the waste amount (e.g., volume and/or weight) and/or a mix of the solid waste into an equivalent measure of carbon (e.g., greenhouse gas) emissions based on the final disposition of the solid waste and according to protocols established by the governing body.

The amount and/or mix of waste discarded by a particular customer, at a particular location, and/or into a particular receptacle 14 may vary over a given time period (e.g., throughout the day, day-to-day, week-to-week, over a season, etc.). Accordingly, a single sample of waste materials from a particular receptacle 14 may be insufficient to determine a baseline carbon footprint associated with a particular customer, location, and/or receptacle. In one embodiment, CPU 24 may determine a number of times that the waste should be collected, an amount of waste that should be collected, and/or a duration of waste collection that provides for statistical confidence in the sample, and only complete step 315 after these requirements have been satisfied.

During and/or after completion of steps 305, 310 and 315, CPU 24 may determine if the solid waste collected at step 305 has divertible content (step 320). In particular, based on the information received via portal 38 (e.g., from sensor(s) 50 and/or input device 48) and/or via portal 40 (e.g., from tracking device 54 and/or manually), CPU 24 may be able to determine an amount of the solid waste being finally disposed of at landfill 16 that could instead be diverted to facility 18. The waste may be divertible, for example, when it can be reused or recycled. Composted waste generally has the same carbon footprint as waste that is disposed of at landfill 16 and, accordingly, may not be considered divertible for the purposes of this disclosure. It should be noted that particular waste components may be reused and/or recycled only in particular geographical areas (e.g., where recycling facilities exist), at particular times (e.g., based on market conditions), and/or under particular conditions (e.g., when the constituents are of a particular size and/or have a particular quality and/or value). CPU 24 may consider these factors (and others), and responsively determine which and how many of the constituents of the collected solid waste disposed of at landfill 16 are currently divertible. If none of the solid waste is divertible, control may return to step 305.

However, if at least some portion of the solid waste collected at step 305 and disposed of at landfill 16 is divertible, CPU 24 may register the baseline carbon footprint with the governing body (e.g., via portal 42—step 325) and suggest or otherwise implement a diversion plan (step 330). The diversion plan may include, for example, placing one or more recycling receptacles 14 at a particular customer location, providing sorting/recycling training or instructions to a customer, transporting collected solid waste first to a sorting facility before finally disposing of it, etc. It is contemplated that, in some situations, the governing body may first need to verify the baseline carbon footprint (e.g., via portal 40) prior to implementation of the diversion plan.

After completion of step 330, CPU 24 may then perform steps 335, 340, and 345 that are similar to (e.g., mirror) steps 305, 310, and 315 described above. In particular, CPU 24 may receive retrieval information (e.g., in association with a reduced amount of solid waste collected from the same customer, location, and/or receptacle, due to the diversion plan); receive final disposition information (e.g., in association with a reduced amount of the collected solid waste being directed to landfill 16 and a greater amount being directed to facility 18); and calculate a reduced carbon footprint associated with the collected solid waste (step 345). Because steps 335-345 may be taken after implementation of the content diversion plan, the newly calculated carbon footprint should be lower than the baseline carbon footprint established at step 315.

CPU 24 may then register the reduced carbon footprint with the governing body, determine an associated carbon offset, and receive from the governing body a corresponding waste coin (Step 350). The carbon offset may be determined as a function of the difference between the current carbon foot print and the baseline carbon footprint. For example, the carbon offset may be determined as a difference between an amount of solid waste originally disposed of at landfill 16 and the amount now disposed of landfill 16; as a difference between an amount of solid waste originally disposed of at facility 18 and the amount now disposed of at facility 18; an amount of solid waste originally collected and an amount now collected; and/or a combination of any of these things. The waste coin awarded may be a function of the amount of carbon offset.

After completion of steps 345 and 350, CPU 24 may post (e.g., via any one or more of portals 38-42) data associated with the carbon footprint, the carbon offset, and the waste coin. This information may be posted in any desired manner for use by the customer, the service provider, the disposal organization, and/or the governing body. In some embodiments, trading of waste coins (e.g., via the governing body and/or a separate carbon vendor or broker) may also be facilitated via system 22.

It will be apparent to those skilled in the art that various modifications and variations can be made to the disclosed system. Other embodiments will be apparent to those skilled in the art from consideration of the specification and practice of the disclosed system. It is intended that the specification and examples be considered as exemplary only, with a true scope being indicated by the following claims and their equivalents.

1. A waste management system, comprising:
a first computing device configured to generate information associated with collection of solid waste and final disposition of collected solid waste;
a second computing device configured to generate a first protocol for registering, verifying, and accounting for an amount and type of collected solid waste diverted from a landfill to a recycling facility;
a memory having computer-executable instructions stored thereon; and
a processing unit in communication with the a first computing device, the second computing device, and the memory, the processing unit being configured to execute instructions to:
receive the information from the first computing device, the first computing device including a first performance sensor;
receive the first protocol from the second computing device;
determine a reduced amount and type of solid waste resulting from a determined content diversion plan, based on information received from the first computing device and the first protocol;
determine a reduced carbon footprint based on the reduced amount and type of solid waste and the first protocol;
register via the second computing device a baseline carbon footprint and the reduced carbon footprint; and
receive via the second computing device a waste coin on a blockchain, the waste coin including publicly verifiable information associated with the baseline carbon footprint and the reduced carbon footprint in response to the registration based on an offset between the baseline carbon footprint and the reduced carbon footprint.

2. The waste management system of claim 1, wherein the first computing device includes:
a first processor configured to generate information associated with collection of solid waste; and
a second processor configured to generate information associated with final disposition of collected solid waste.

3. The waste management system of claim 2, wherein the second computing device is a governing body computing device.

4. The waste management system of claim 2, wherein the first processor is coupled to a locating device configured to generate location data and one or more sensors configured to generate image data and performance data.

5. The waste management system of claim 1, wherein the information associated with collection of solid waste includes an amount of solid waste collected, a collection timestamp, and a collection location.

6. The waste management system of claim 5, wherein the information associated with collection of solid waste further includes a mixture composition of types of solid waste.

7. The waste management system of claim 1, wherein the processing unit is further configured to execute the instructions to receive, via the second computing device, verification of the baseline carbon footprint and the reduced carbon footprint.

8. The waste management system of claim 7, wherein the verification includes verification of the collection of solid waste by a service vehicle and verification of final disposition of solid waste at the landfill or recycling facility.

9. The waste management system of claim 8, wherein the processing unit is further configured to execute the instructions to receive, via the second computing device, a serial number corresponding to the offset between the baseline carbon footprint and the reduced carbon footprint.

10. The waste management system of claim 9, wherein the waste coin is a virtual monetary representation of a serialized unit of carbon offset.

11. waste management system of claim 1, wherein:
the processing unit is further configured to execute the instructions to suggest or implement the determined content diversion plan; and
the reduced carbon footprint results from implementation of the content diversion plan.

12. A waste management system, comprising:
a locating device configured to generate a first signal associated movement of a service vehicle during at least one of collecting of solid waste and disposing of solid waste at a landfill or recycling facility;
one or more sensors configured to generate a second signal indicative of an amount of solid waste collected by the service vehicle and delivered to the landfill or recycling facility, the one or more sensors including a first performance sensor;
a memory having computer-executable instructions stored thereon; and
a processing unit in communication with the locating device, the one or more sensors, and the memory, the processing unit being configured to execute instructions to:
determine a reduced amount and type of solid waste resulting from a determined content diversion plan, based on information received from the locating device and the one or more sensors;
determine a reduced carbon footprint based on the reduced amount and type of solid waste and a first protocol for registering, verifying, and accounting for an amount of collected solid waste diverted from the landfill to a recycling factory;
register a baseline carbon footprint and the reduced carbon footprint with a governing body; and
receive a waste coin on a blockchain, the waste coin including publicly verifiable information associated with the baseline carbon footprint and the reduced carbon footprint from the governing body in response to the registration based on an offset between the baseline carbon footprint and the reduced carbon footprint.

13. The waste management system of claim 12, wherein the one or more sensors further include an optical sensor configured to generate an image of the solid waste.

14. (canceled)

15. The waste management system of claim 12, wherein the second signal indicates at least one of a weight and a volume of the solid waste collected by the service vehicle.

16. The waste management system of claim 12, wherein:
the waste management system further includes a manual input device; and
the processing unit is further configured to execute the instructions to:
receive input from a user via the manual input device, the input being indicative of visual observations of the solid waste collected by the service vehicle; and
determine the baseline carbon footprint or the reduced carbon footprint based further on the input.

17. The waste management system of claim 12, wherein the processing unit is further configured to execute the instructions to receive, from the governing body, verification of the baseline carbon footprint or the reduced carbon footprint prior to receiving the waste coin.

18. The waste management system of claim 17, wherein the verification includes verification of collection of the solid waste by the service vehicle and verification of final disposition of the solid waste at the landfill or recycling facility.

19. The waste management system of claim 18, wherein:
the processing unit is further configured to execute the instructions to receive from the governing body a serial number corresponding to the offset between the baseline carbon footprint and the reduced carbon footprint; and
the waste coin is a virtual monetary representation of a serialized unit of the offset.

20. The waste management system of claim 12, wherein the processing unit is further configured to execute the instructions to suggest or implement the determined content diversion plan.

21. A computer-implemented method, comprising:
receiving from a first computing device, information associated with collection of solid waste and final disposition of collected solid waste, the first computing device including a first performance sensor;
receiving a first protocol for registering, verifying and accounting for an amount and type of collected solid waste diverted from a landfill to a recycling facility from a second computing device;
determining a reduced amount and type of solid waste resulting from a determined content diversion plan, based on information received from the first computing device and the first protocol;
registering via the second computing device, a baseline carbon footprint and the reduced carbon footprint; and
receiving, via the second computing device, a waste coin on a blockchain, the waste coin including publicly verifiable information associated with the baseline carbon footprint and the reduced carbon footprint in response to the registration based on an offset between the baseline carbon footprint and the reduced carbon footprint.
